(19) United States
(12) Patent Application Publication
(10) Pub. No.: US 2020/0384550 A1
(43) Pub. Date: Dec. 10, 2020

(54) Apparatus and method enabling one person to layout and install wall anchors for large wall decor items

(71) Applicant: Robert W. Miller, Huntington Beach, CA (US)

(72) Inventor: Robert W. Miller, Huntington Beach, CA (US)

(21) Appl. No.: 16/501,785

(22) Filed: Jun. 10, 2019

(51) Int. Cl. B23B 47/28; F16B 13/00

(52) U.S. Cl. CPC B23B 47/287; F16B 13/00

(57) ABSTRACT

A tool that will enable one person to easily review alternate wall positions for major décor items, and complete the required installation. The frame of tool is ruled from the mid-point outward, with a bubble-level at the tool center, and RH and LH Sliders that would be set to provide a virtual display of the top corners of the décor item to be installed. A simple added procedure can add display of all 4 corner positions. The tool has deployable adhesive tabs (DAT)s that can be engaged to a wall surface to firmly hold the tool in position on wall. This feature allows the decorator to stand back for wide views of a position without any measuring or marking. When a position is decided, the drill guides in the Sliders are in position to install dual wall-anchors.

Long versions of tool would use new design composite hinges to have a frame that folds lengthwise.

The surface conforming drywall inserts described in this patent have an improved configuration that is installed with a user-friendly PVA base resin adhesive. This patent also describes a micro-fiber gasket useful to absorb resin extruded from around inserts of a bonded assembly during the installation and cure-cycle process.

### BACKGROUND OF THE INVENTION

### Field of the Invention

The present invention relates to the task of decorating one's home or place of business, particularly the task of wall location selection, layout and installation of large wall décor items.

### Description of the Prior Art

The decorating process typically involves the “owner” assembling a mental image of plan for the new wall decor. This image would include the general location of the major décor item(s) that is the centerpiece of the wall decoration. But specific location typically will have to be determined by integral steps of translating the art “image” to obtain the artistic effect the director envisions. Typically an owner will direct the project and have one or two “volunteers” to assist in the required wall measuring, marking and installations. Simple tools involved would be: stepladder, tape-rule, plumb-bob, masking-tape, markers, 12″ level.

Following are the typical steps of prior art

1. The director physically points to the wall positions for top-corners of the artwork.

2. The assistant climbs stepladder to mark the position on wall for top corner #1, and then uses the plumb-bob to locate the point on floor directly below this top corner.

3. The assistant measures and records the height above floor of top corner #1. From this top corner, the assistant lays out horizontally the dimension of the width of the décor object, and makes a temporary vertical mark on the wall.

4. On the floor, the assistant lays out the width of the artwork and marks this reference point on the floor.

5. The assistant goes up the step-ladder and marks off the height dimension of corner #1 onto the vertical line from step 3. These intersecting lines would be the position of top-corner #2.

6. Director then decides whether this location is quite correct.

### SUMMARY OF THE INVENTION

Accordingly, it is the general purpose and object of the present invention to provide a tool that can facilitate position selection for major wall-décor items, and provide for improved process and materials for installation of required wall hardware. This inventive tool can be immediately moved to prospective wall positions and hold itself to the wall to allow the user the ability to quickly look at a number of positions without having to do any measuring or marking. When the location is finally decided, the tool will serve as a drill guide for installation of required drywall inserts. This patent application recommends and describes an improved structural insert for drywall panels of the type previously claimed in U.S. Pat. No. 8,404,065.

Further and additional objects of the invention shall become apparent upon examination of the description that follows in conjunction with the appended drawings.

The frame of tool resembles a yardstick that is ruled from mid-point outward with a bubble-level at tool center. The tool-frame is made from hardwood plywood, with a typical length of 36 inches by 1.5 inch width. The tool frame has RH and LH Sliders, markers that are adjusted to provide a virtual display of the top corner positions of décor if installed at the given position. The rear face of tool has friction pads positioned to facilitate holding the tool firmly in position as tool is being engaged to a wall position. Adjacent to the friction pads are short frame-tabs of polymeric tape material that extend up from frame approximately ¾ inch that are the attach point of DATs to the frame.

The DATs (deployable adhesive tabs) are 3.5 inch length sections of a polymer adhesive tape that has a 0.40 inch overlap at one end to facilitate handling the high tack material. They are an expendable item that will lose adhesive capability after a number of applications. Spare DATs are stored on the tool.

The Slider markers are 3 sided aluminum saddles, closed out at the bottom with a section of hardwood that will also serve as the material for the bore of the drill-guide section of the Slider.

The tool length needs to be of a length greater than the width of the object to be installed. Tools for widths greater than 30″ inches will have a folding frame (see FIG. 1) for shipping and storage convenience. The hinge of the folding frame is a new design, low profile (10 mil) +/−45 fiber-reinforced composite that maintains rigid alignment across the adjoined sections. (See Design patent application Ser. No. 29/651,902)

This invention includes description for a new drywall insert that is improved over the insert design described in our previous U.S. Pat. No. 8,404,065. The new insert design is cylindrical shape with an exterior surface that is a standard NC thread. These externally threaded inserts will use an Insert-Driver hand-tool to rigidly hold the insert as it applies the forces to drive the insert into drywall panel. FIG. 8

Prior to insert installation, the ¼″ diameter pilot-holes directed by the Sliders will be bored out to size specified for the self-tapping inserts. The specified PVA based adhesive will be applied to the surface of drilled bore in the drywall, and to the exterior thread of the insert.

In the installation process, the Insert-Assembly will be screwed into the bore by the forward/CW forces applied to the Insert by the Insert-Driver hand-tool. The PVC Insert being much stronger that the drywall, carves its external thread shape into the bore. As the insert moves forward, the adhesive around the insert will be forced into the carved thread area to reinforce the drywall, and structurally lock the insert into panel flush to wall surface.

The insert installation is further improved by addition of an inventive micro-fiber gasket to the Insert-Assembly to soak up excess adhesive resin that can bleed out of the bond area between the insert and the wall panel during the installation process. This new micro-fiber gasket is a laminated composite combining a 6.5 oz/sq yd micro-fiber fabric with a 4 mil heavy duty polymeric adhesive tape. The compressed thickness of this gasket is 0.020″. See FIG. 7

This micro-fiber gasket will be under the depth limiting metal washer of the Insert-Assembly. The metal washer will be dimpled to bring the installed insert flush to wall.

As the insert installation approaches desired flush wall position, the required turning force on tool will increase and finally resist advancement. Insert Driver tool is then reversed, leaving Insert in wall position. An over-night cure completes the structural bond of insert into wall panel.

The basic Wall-Layout Tool only displays the virtual location for the two top corners of the décor item to be installed. However, at times the decorator would like to have all four corner locations displayed. This Application describes self-adhesive tabs and method to use to display the additional corners. See Para. [0024].

### BRIEF DESCRIPTION OF DRAWINGS

FIG. 1A is perspective illustration of the front face of the standard hinged version of Wall-Layout Tool showing the LH and RH Sliders and the LH and RH frame tabs, with the RH frame tab showing DAT attached. Also shown at center is sliding section that slides on frame to lock or unlock hinge.

FIG. 1B is a rear cross section of the tool frame (without sliders), showing the location of the Frame-Tabs. Friction Pads are located on both sides of each frame-tab. At center is a view of the new composite hinge for the tool that joins the two sections. (Hinge-lock section is not shown in this view)

FIG. 3 (previously deleted)

FIG. 4A is a perspective illustration of a extended-length version of tool frame, depicting the tool being folded flat.

FIG. 4B depicts the compressive sleeve section that is slid over the top edge of tool frame hinge to lock the adjoined sections in open position.

FIG. 5 is illustration of inventive Insert assembly. The included Table shows insert sizes and drill bore size for installation in drywall.

FIG. 6 is a perspective illustration of the Bore-Trimmer tool.

FIG. 7 depicts the material for the Micro-Fiber Gasket of the insert assembly. The material is a plied combination of a 4 mil polymeric adhesive tape with a 6.5 ounce/sq. yd. micro-fiber fabric.

FIG. 8 Shows the Install-tool assembled with fiber-gasket, offset-washer and Insert.

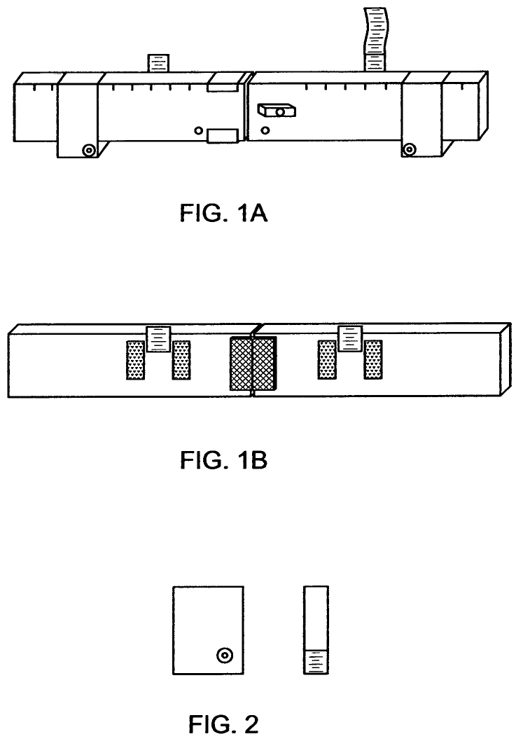

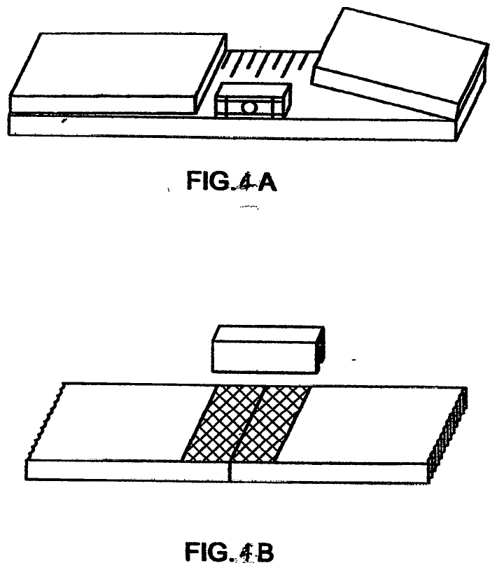

### DESCRIPTION OF THE PREFERRED EMBODIMENT AND THE METHOD OF USE THEREOF

### Using the Layout Tool

A. Place tool on a flat surface. Slide the latch for hinge to ‘LOCK’. Set the LH and RH sliders of the tool to the width between top corners of item being installed.
B. Pull a DAT from Spares positioned on tool. Holding DAT at its folded tab end, orient DAT to have its adhesive face down and line up the adhesive end of DAT to overlap the Frame-tab extending up from rear face of Tool. When DAT is aligned, pinch the DAT to tab. Repeat for opposite side. Tool is ready to secure to wall.
C. Hold the Tool level with both hands with the thumbs at bottom side of frame below the DATs and the index finger tips just touching the DAT at top edge of frame. When tool is at the potential wall location, check for “level” and press tool to wall.
D. Run your index-fingers up the DAT to smooth to the wall.
E. Check Level. Stand back for a wide view of the wall position.
(If position is not “perfect”, pull the tool and move to next alternate location.)
   F. When position is decided, use Drill-guides of Sliders to drill pilot-holes for dual wall anchors.
   NOTE: The wall-layout tool only directly provides virtual wall position for the top two corners of item to be installed. However, paragraph [0024] describes procedure to also include a virtual display of the lower corners.

### Wall Anchor Insert Resin Coating and Installation

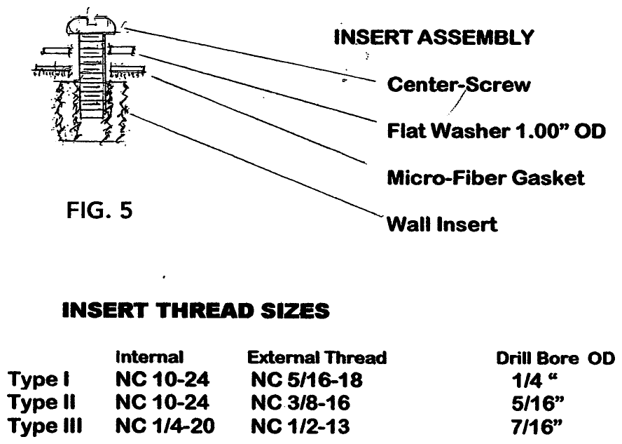

1. Drill ¼″ pilot holes at the drill-guide ports of the Layout Tool. Bore-out the pilot holes to the bore required for the inserts. See FIG. 5

2. Typically, drilling a hole in drywall results in a build up of fibrous drywall material around the bore. That residue needs to be removed to allow a flush-to-wall installation of a wall insert. Suggest use of a Bore-Trimmer to shave off this residue. See paragraph [0023]

3. Coat inside surface of drilled bore with specified adhesive. Dip-coat a ¾″ length end of supplied dowel rod into the specified PVA adhesive and deposit into bore. Then with a rolling motion, coat the inside of the hole.

4. Use the supplied dowel rod to transfer a thin coat of adhesive to the exterior thread of Insert that is assembled on the Installation Tool.

5. Align the Installation Tool assembly into the coated bore, and with a forward pressure and clock-wise turning force—Screw the insert-assembly into the bore. Continue until the micro-fiber gasket is flush to the wall and further clock-wise turning is resisted.

6. Using two fingers of one hand—Firmly press opposing corners of the metal insert of gasket-assembly flush to the wall. Slowly apply CCW force to the Tool to the release the thread-lock of the tool to insert.

7. Remove tool. Discard gasket. Clean up any residual resin from the wall surface with wet/dry shop towels.

8. Allow over-night cure of adhesive prior to application of heavy loads to installed wall anchors.

### Description of Prior Art U.S. Pat. No. 8,404,065

The prior art for installing wall inserts U.S. Pat. No. 8,404,065 described a Method and Apparatus for installing a Surface Conforming Drywall Anchor. This prior patent describes a PVC wall insert that was basically cylindrical, with a bullet shaped nose and a center bore with a standard NC machine thread. The bore-hole made in drywall for the insert was a larger diameter to allow a slip-fit of insert to bore. That insert used a moisture curing urethane adhesive that expanded during cure to lock insert into drywall. The urethane adhesive was suitable for the purpose, but it does have the drawback of some health concerns for the user, and a major drawback in the difficulty to clean-up resin from “squeeze-out” and spills.

### Description of New Insert

The insert described in this new patent is PVC material, however, the exterior barrel on the new insert is a standard machine-thread, i.e. NC 5/16-18, NC ⅜-16 or NC ½-13. The center bore of this insert is also a NC machine thread. This externally threaded insert, will be installed in the drilled bores sized for the NC thread. The PVC insert being much stronger than the drywall, carves its own external thread shape into the bore-hole like a standard HSS tap carves its thread into a metal bore. Result is a tight fit of insert into drywall panel that does not need an expanding adhesive, as there is no gap between the drywall and insert. The adhesive for this new insert is a high viscosity, water-soluble PVA resin (Poly Vinyl Acetate). This adhesive reinforces the drywall around the insert, and structurally bonds the insert into panel.

### Description of Bore-Trimmer

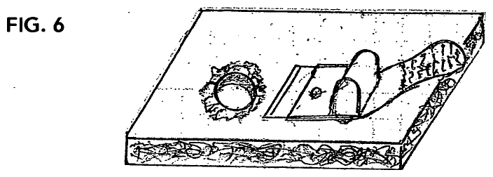

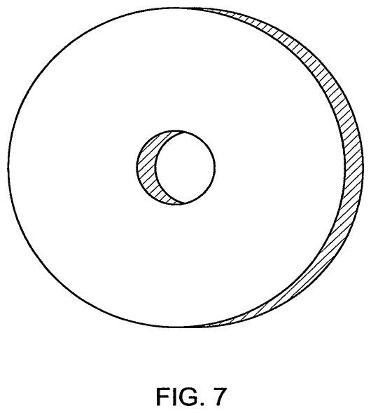

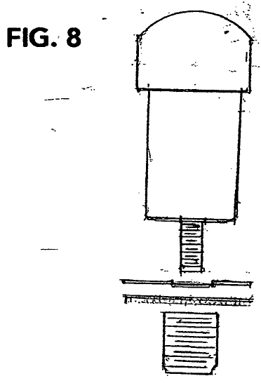

One will understand that this insert installation relies on the washer of the Insert-Assembly to act as a limiter for placing the insert flush to wall surface. Any residue around drill bores has to be removed to allow the washer to come flush to wall-surface. Typically, the drilled holes in a drywall-panel will have a surrounding build-up of residue that is difficult to remove. A tool recommended to eliminate this problem is a Bore-Trimmer. (See FIG. 6) This Bore-Trimmer design has a single-edge razor-blade positioned to have the lower edge of the wedge of blade flush to wall surface. The bore-trimmer is held flat to surface by slight hand pressure from thumb and two fingers at center knob, and steered by the rudder handle with opposite hand.

A preferred method of using tool is to use the corner tip of blade to cut into the ring of residue, and then with a slicing motion, shave the residue from wall surface.

### Method to Display Virtual Position of Lower Corners

Lower Corner-Markers are—0.025″ t aluminum coupons 1.0″ tall×1.25″ width. Coupons will have an indicator mark like the Sliders to indicate virtual RH or LH corner positions. The coupons have a 1.5″ length pigtail of the 1″ wall tape having a 0.3″ overlapped end to facilitate handling the tape. This tape section is adhesively attached to center-top face of marker with a 0.3″ lap joint. When lower corner markers are not in use, they can be stored on the tool. When lower corner marker is needed—Pull up pigtail by its tab and it is ready to apply to wall position.

Method—Use a light-weight (2-4 oz.) locking tape-rule. Extend tape to approximately 4″ beyond height dimension of décor item. Hang the extended tape-rule on the installed Wall-Layout Tool, adjacent to LH top-corner marker Slider. Follow that line straight down from the top corner to the height dimension of the décor item. Attach the LH corner-marker on the wall at the position where the line from top corner marker intersects with the height dimension of the wall item. Use same procedure to locate the position for the RH lower-corner marker.

1. A tool for wall layouts that facilitates tasks involved with layout and installation of hardware for major wall décor objects. The tool comprises an elongate frame that is ruled from mid-point outward with a bubble level at center. The tool frame has RH and LH Sliders that would be set to display top width of object to be installed. The tool has deployable adhesive tabs (DAT)s that can be engaged to a wall surface to hold the tool in position on wall.

2. The tool recited in claim 1 wherein the Sliders of tool contain drill-guide ports, so that when a location is decided, the drill-guides are in position to drill pilot-holes for required dual wall anchors. The Sliders also have a tab extending from rear face of Slider that is the attach point for the DATs.

3. The Tool recited in claim 1 that has uses inventive low-profile composite hinges to allow its elongate frame to fold flat for shipping and storage considerations. This low-profile hinge allows free movement of sliders across hinged frame. See patent application Ser. No. 29/651,902.

4. A new drywall insert that is improved over insert described in U.S. Pat. No. 8,404,065. The external barrel shape of this new PVC insert is a standard machine thread. In the installation process this insert carves a matching thread shape into the drilled bore hole and in the process uses a PVA base adhesive to reinforce the surrounding bore and lock the insert into position.

5. A composite micro-fiber gasket material for use in the insert installation is described. The gasket will absorb adhesive resin that is extruded around potted inserts during the installation/curing process.
